(19) United States
(12) Patent Application Publication
(10) Pub. No.: US 2010/0017612 A1
(43) Pub. Date: Jan. 21, 2010

(54) Electronic Apparatus and Communication System

(75) Inventor: Tadahiro Aihara, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/146,339

(22) Filed: Jun. 25, 2008

(30) Foreign Application Priority Data
Jun. 29, 2007 (JP) 2007-173366

(51) Int. Cl. H04L 9/00

(52) U.S. Cl. 713/171; 713/168

(57) ABSTRACT

According to one embodiment, an electronic apparatus includes a display process unit and a data transmission process unit. The display process unit is configured to display connection confirmation information, which is known to a user and is transmitted from a device via a network during a connection establishing process for establishing connection between the device and an electronic apparatus, on a display screen of the electronic apparatus. The data transmission process unit is configured to start a process of transmitting the data that is to be kept secret to the device via the network in response to a predetermined user operation which indicates that the user has confirmed that the connection confirmation information displayed on the display screen is correct.

### CROSS-REFERENCE TO RELATED APPLICATIONS

This application is based upon and claims the benefit of priority from Japanese Patent Application No. 2007-173366, filed Jun. 29, 2007, the entire contents of which are incorporated herein by reference.

### BACKGROUND

1. Field

One embodiment of the invention relates to an electronic apparatus which transmits data, which is to be kept secret, to a device via a network, and to a communication system using the electronic apparatus.

2. Description of the Related Art

In general, in the communication via the Internet, an encryption technology, a signature technology, etc. are used as technologies for securely transmitting data from a data-transmission-side device to a data-reception-side device.

Recently, even in a small-scale network for use in homes and small offices, there has been a demand for a technology for securely transmitting data, which is to be kept secret, from one device to another on the network.

Wi-Fi Protected Setup (WPS) is a specification for supporting security setup in a wireless LAN environment. In the WPS specification, two setup functions, namely, a push-button method and a PIN (Personal Identification Number) code method, are defined.

In the push-button method, if buttons of two devices are depressed by a user, the two devices start communication. In the push-button method, however, it is possible that if a third person accidentally or intentionally presses a button of some other device on the network while the user is performing an operation of pressing a button of a certain device, data may erroneously be transmitted to this other device.

On the other hand, in the PIN code method, it is necessary for the user himself/herself to input a PIN (Personal Identification Number) code, which is unique to a device which is to be made to take part in the network, or a PIN code, which is automatically generated by this device, to a device which already takes part in the network. By the input of the PIN code, it becomes possible to prevent an unintended device from taking part in the network, and to prevent erroneous transmission of data to this unintended device.

Jpn. Pat. Appln. KOKAI Publication No. 2006-50372 discloses a wireless LAN connection system wherein when a power button of a device, which is to be made to take part in a network, is pressed by a user, communication between this device and an access point on the network is started. This wireless LAN connection system can be regarded as a kind of push-button method.

As described above, the push-button method is easy to operate, but is lacking in security. On the other hand, the PIN code method has high security, but is poor in operability since the user himself/herself has to input the PIN code by typing.

Therefore, it is necessary to realize a novel function which can satisfy both usability and security.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a structure of a communication system including an electronic apparatus according to an embodiment of the invention;

FIG. 2 is an exemplary block diagram showing a functional configuration of the electronic apparatus according to the embodiment;

FIG. 3 is an exemplary block diagram showing another functional configuration of the electronic apparatus according to the embodiment;

FIG. 4 is an exemplary block diagram showing a functional configuration of a device which is used in the communication system shown in FIG. 1;

FIG. 5 is an exemplary block diagram showing the hardware configuration of each of the electronic apparatus of the embodiment and the devices used in the communication system shown in FIG. 1;

FIG. 6 shows an example of the procedure of a series of processes which are executed by the electronic apparatus of the embodiment; and

FIG. 7 shows another example of the procedure of a series of processes which are executed by the electronic apparatus of the embodiment.

### DETAILED DESCRIPTION

Various embodiments according to the invention will be described hereinafter with reference to the accompanying drawings. In general, according to one embodiment of the invention, there is provided an electronic apparatus which transmits data, which is to be kept secret, to a device via a network, including: a display process unit configured to display, on a display screen of the electronic apparatus, connection confirmation information which is known to a user and is transmitted from the device via the network during a connection establishing process for establishing connection between the device and the electronic apparatus; and a data transmission process unit configured to start a process of transmitting the data that is to be kept secret to the device via the network in response to a predetermined user operation which indicates that the user has confirmed that the connection confirmation information displayed on the display screen is correct.

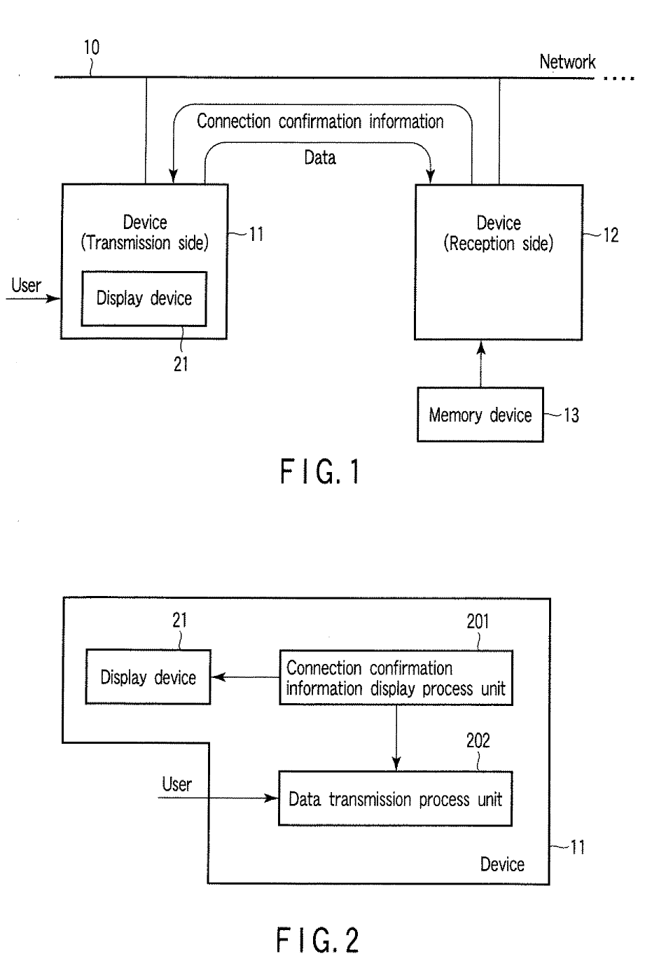

FIG. 1 shows a configuration of a communication system including an electronic apparatus according to an embodiment of the invention. This communication system comprises a network 10 and a plurality of devices (device 11, device 12, . . . ) which are connected to the network 10. The network 10 is composed of, for example, a LAN.

The device 11 is the electronic apparatus of the present embodiment, and is realized by, for instance, a TV set or a personal computer. The device 11 functions as a transmission-side device which transmits, e.g. data, which is to be kept secret, to the device 12 via the network 10.

The device 12 is a reception-side device which receives, e.g. the data to be kept secret that is transmitted from the device 11. The reception-side device 12 is realized by, for instance, a video recorder.

Each of the device 11 and device 12 may have both functions of a transmission-side device and a reception-side device. In a case where data is transmitted from the device 11 to the device 12, the device 11 functions as the transmission-side device and the device 12 functions as the reception-side device. On the other hand, in a case where data is transmitted from the device 12 to the device 11, the device 12 functions as the transmission-side device and the device 11 functions as the reception-side device.

In the description below, it is assumed that the device 11 functions as the transmission-side device and the device 12 functions as the reception-side device.

The data to be kept secret is, for example, login information (account ID, password, etc.) which is necessary for the transmission-side device 11 to log in to the reception-side device 12. The transmission-side device 11 logs in to the reception-side device 12, for example, in order to instruct the reception-side device 12 to execute a TV recording function. After logging in to the reception-side device 12, the transmission-side device 11 transmits video-recording programming information (channel number, recording data/time, etc.) for designating broadcast program data, which is to be recorded, to the reception-side device 12 via the network 10.

In order to securely transmit data to be kept secret, such as login information, to the reception-side device 12, the transmission-side device 11 executes a process, which is to be described below, during a connection establishing process for establishing connection between the transmission-side device 11 and the reception-side device 12. The connection establishing process is automatically started, for example, when the user presses a button on the transmission-side device 11 and a button on the reception-side device 12.

Specifically, the transmission-side device 11 receives connection confirmation information which is transmitted from the reception-side device 12 via the network 10 during the connection establishing process. The connection confirmation information is information which is known to the user (or known to only the user). The transmission-side device 11 displays the received connection confirmation information on a display screen of a display device 21 which is provided on the transmission-side device 11, thereby prompting the user to confirm whether the connection confirmation information is correct or not. The connection confirmation information is information (password information) corresponding to the above-described PIN code. For example, user data, such as image data, which is stored in a memory device 13 that is connected to the reception-side device 12 by the user, is used as the connection confirmation information.

Alternatively, a random number, for instance, which is automatically generated by the reception-side device 12 and displayed on a display screen of the reception-side device 12, may be used as the connection confirmation information.

The user confirms whether the connection confirmation information that is displayed on the display device 21 of the transmission-side device 11 is correct or not, that is, whether the connection confirmation information agrees with the connection confirmation information that is known to the user (the user data or random number). If the connection confirmation information that is displayed on the display device 21 is correct, the user determines that connection is established between the transmission-side device 11 and the reception-side device that is intended by the user. The user performs a user operation which indicates that the user has confirmed that the connection confirmation information displayed on the display device 21 is correct, for example, an operation of pressing the button of the transmission-side device 11.

Responding to the user operation, the transmission-side device 11 determines that the reception-side device 12, which has established connection to the transmission-side device 11, is the reception-side device that is intended by the user (i.e. the reception-side device confirmed by the user), and starts a process of transmitting data that is to be kept secret, such as login information, to the reception-side device 12 via the network 10. Thereby, the data to be kept secret can correctly be transmitted to the reception-side device 12 that is intended by the user, and the data to be kept secret can be prevented from being incorrectly transmitted to some other device on the network 10.

FIG. 2 shows an example of the configuration of the transmission-side device 11.

The transmission-side device 11 includes a connection confirmation information display process unit 201 and a data transmission process unit 202. The connection confirmation information display process unit 201 receives the connection confirmation information which is transmitted from the reception-side device 12 in the connection establishing process, and displays the received connection confirmation information on the display screen of the display device 21. Responding to the user operation which indicates that the user has confirmed that the connection confirmation information displayed on the display device 21 is correct, the data transmission process unit 202 starts the process of transmitting the data that is to be kept secret to the reception-side device 12 via the network 10.

In the connection establishing process, an encrypted secure communication path can be established between the transmission-side device 11 and the reception-side device 12. In this case, the transmission-side device 11 executes, in the connection establishing process, a process for exchanging a key between the reception-side device 12 and the transmission-side device 11 via the network 10, and generates a secret key (common key) which is shared by the reception-side device 12 and the transmission-side device 11. Similarly, a secret key (common key) is generated in the reception-side device 12.

The connection confirmation information, which is transmitted from the reception-side device 12, is encrypted by the secret key that is generated by the reception-side device 12. The transmission-side device 11 decrypts the encrypted connection confirmation information, which is transmitted from the reception-side device 12, by the secret key that is generated by the transmission-side device 11, and displays the decrypted connection confirmation information on the display screen. If the transmission-side device 11 has the same secret key as the secret key of the reception-side device 12, the transmission-side device 11 can correctly decrypt the encrypted connection confirmation information.

The user confirms whether the connection confirmation information that is displayed on the display device 21 of the transmission-side device 11 is correct or not, that is, whether the connection confirmation information agrees with the connection confirmation information that is known to the user (the user data or random number). If the connection confirmation information that is displayed on the display device 21 is correct, the user performs a user operation which indicates that the user has confirmed that the connection confirmation information displayed on the display device 21 is correct, for example, an operation of pressing the button of the transmission-side device 11.

Responding to the user operation, the transmission-side device 11 determines that the connection to the reception-side device that is intended by the user is established, and that the secure transmission path for securely transmitting the data to be kept secret, such as the login information, is set. Thus, the transmission-side device 11 starts the process of transmitting the data to be kept secret to the reception-side device 12 via the network 10. In this case, the data to be kept secret is encrypted by the secret key that is generated by the transmission-side device 11, and the encrypted data is transmitted to the reception-side device 12 via the network 10. Thereby, the data to be kept secret can more securely be transmitted to the reception-side device 12, and the data to be kept secret can be prevented from being incorrectly transmitted to some other device on the network 10. Moreover, even if this data is hacked by some other device, the data to be kept secret can be prevented from being decrypted.

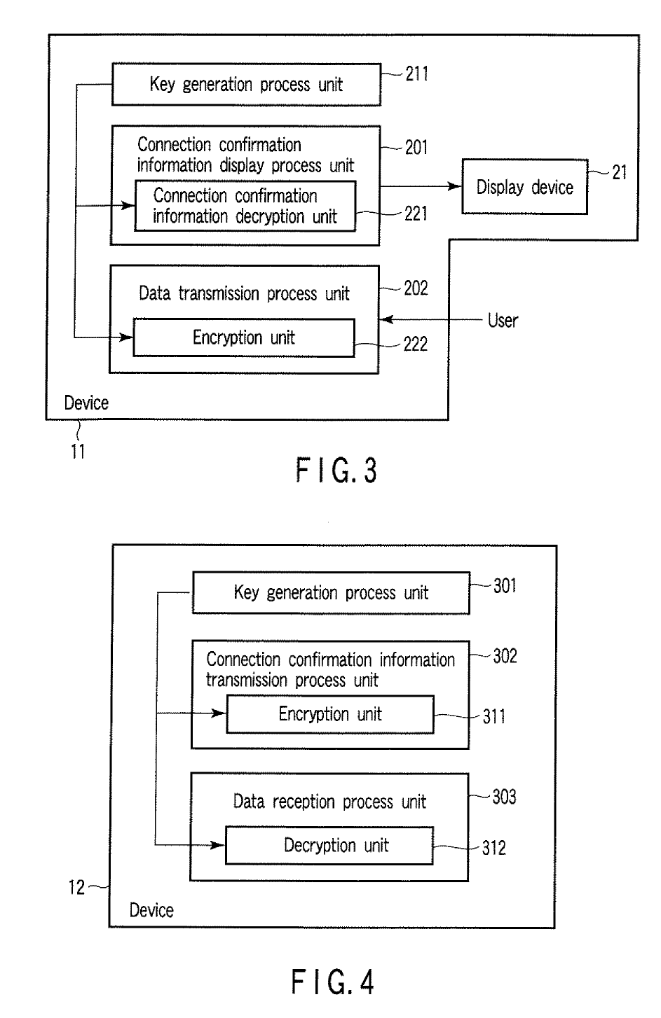

FIG. 3 shows an example of the configuration of the transmission-side device 11 having a secret key sharing function.

The transmission-side device 11 includes a key generation process unit 211 in addition to the above-described connection confirmation information display process unit 201 and data transmission process unit 202.

The key generation process unit 211 executes, during the connection establishing process, a key exchange process for exchanging a key between the reception-side device 12 and the transmission-side device 11 via the network 10, and generates a secret key (common key) which is shared by the reception-side device 12 and the transmission-side device 11.

The connection confirmation information display process unit 201 includes a connection confirmation information decryption unit 221. The connection confirmation information decryption unit 221 decrypts the encrypted connection confirmation information, which is transmitted from the reception-side device 12, by the secret key that is generated by the key generation process unit 211. The connection confirmation information display process unit 201 displays the connection confirmation information, which has been decrypted by the connection confirmation information decryption unit 221, on the display screen of the display device 21.

The data transmission process unit 202 includes an encryption unit 222. Responding to the user operation which indicates that the user has confirmed that the connection confirmation information displayed on the display device 21 is correct, the encryption unit 222 encrypts the data to be kept secret by the secret key that is generated by the key generation process unit 211. The data transmission process unit 202 transmits the data, which is encrypted by the encryption unit 222, to the reception-side device 12 via the network 10.

FIG. 4 shows an example of the configuration of the reception-side device 12 having a secret key sharing function.

The reception-side device 12 includes a key generation process unit 301, a connection confirmation information transmission process unit 302 and a data reception process unit 303.

The key generation process unit 301 executes, during the connection establishing process, a key exchange process for exchanging a key between the transmission-side device 11 and the reception-side device 12 via the network 10, and generates a secret key (common keys which is shared by the transmission-side device 11 and the reception-side device 12. This secret key is the same as the secret key that is generated by the transmission-side device 11.

The connection confirmation information transmission process unit 302 includes an encryption unit 311. The encryption unit 311 encrypts the connection confirmation information by the secret key that is generated by the key generation process unit 301. The connection confirmation information transmission process unit 302 transmits, in the connection establishing process, the encrypted connection confirmation information to the transmission-side device 11 via the network 10.

The data reception process unit 303 receives the encrypted data which is transmitted from the transmission-side device 11. The data reception process unit 303 includes a decryption unit 312. The decryption unit 312 decrypts the received encrypted data by the secret key that is generated by the key generation process unit 301.

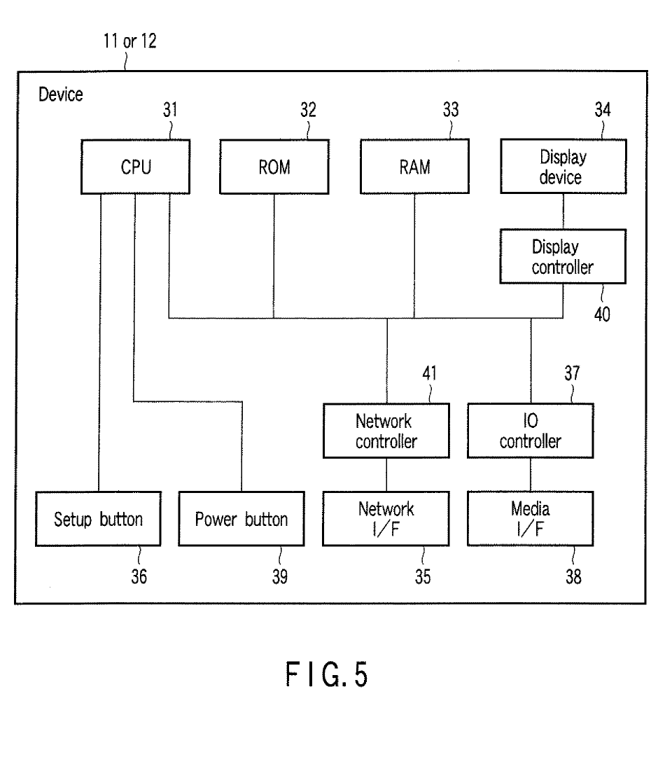

Next, referring to FIG. 5, an example of the hardware configuration of each of the device 11 and device 12 is described.

As has been described above, each of the device 11 and device 12 has both the functions of the transmission-side device and reception-side device. Accordingly, the device 11 and device 12 have the same function for executing a communication process.

Each of the device 11 and device 12 includes a CPU 31, a ROM 32, a RAM 33, a display device 34, a network interface 35, a setup button 36, an IO controller 37, a media interface 38, a power button 39, a display controller 40 and a network controller 41.

The CPU 31 executes various programs which are stored in the ROM 32. The programs include a program for controlling a communication process and a program for executing a TV function/video recorder function. Under the control of the CPU 31, the IO controller 37 accesses the above-described memory device 13 which is inserted in the media interface 38. The memory device 13 is, for example, a removable memory device such as a memory card.

The display controller 40 controls the display device 34. In the case where the hardware configuration of FIG. 5 corresponds to the device 11, the display device 34 corresponds to the display device 21 in FIG. 1.

The network controller 41 controls communication with the network 10 which is connected to the network interface 35. The setup button 36 comprises at least one button which is operable by the user. Each button may be a hardware button such as a push button switch, or a software button such as a button (icon) which is displayed on the display screen of the display device 34.

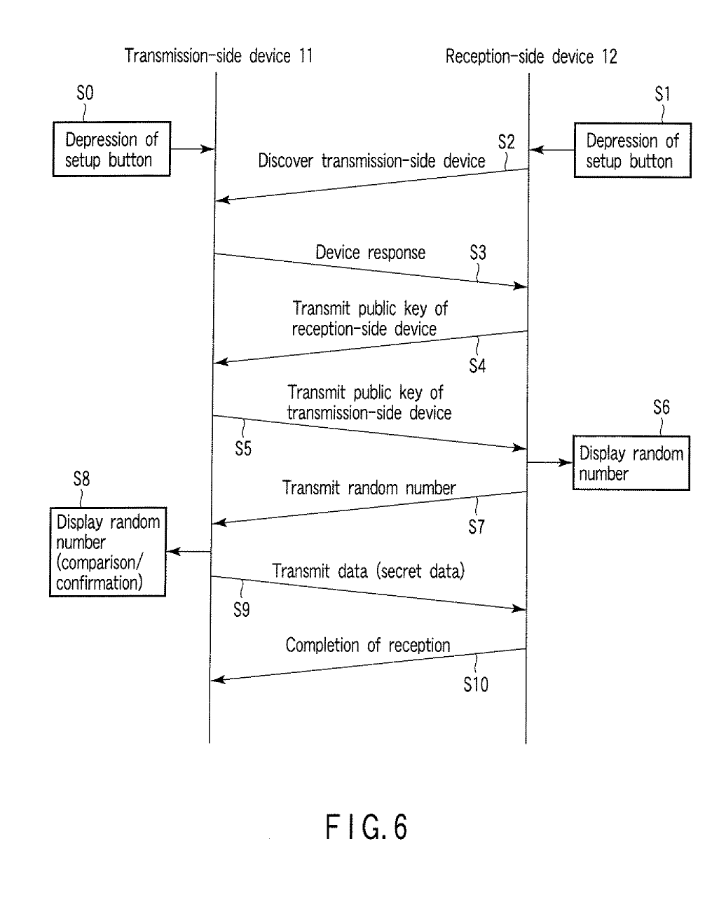

Next, referring to FIG. 6, a description is given of an example of the procedure of a series of processes for transmitting data from the transmission-side device 11 to the reception-side device 12. In FIG. 6, it is assumed that a random number is used as the above-described connection confirmation information.

For example, TCP/IP or UDP/IP is used for the communication between the transmission-side device 11 and the reception-side device 12. It is also assumed that the transmission-side device 11 and the reception-side device 12 belong to the same subnet.

Step S0: If the user presses, for example, the setup button 36 of the transmission-side device 11, the transmission-side device 11 starts a communication protocol for connection to a reception-side device, and first transitions into a standby state. In the standby state, the transmission-side device 11 waits for a discover packet from the reception-side device, for example, at UDP port No. 33333.

Step S1: If the user presses, for example, the setup button 36 of the reception-side device 12, the reception-side device 12 starts a communication protocol for connection to a transmission-side device.

Step S2: The reception-side device 12 first broadcasts a packet which designates UDP/IP port No. 33333, thereby to discover the transmission-side device 11.

Step S3: The transmission-side device 11, which has received this broadcast packet, transmits a UDP/IP packet including the IP address of the transmission-side device 11 to the reception-side device 12 (device response).

Step S4: The reception-side device 12 generates a secret key and a public key, for example, by a DH (Diffie-Hellman) method, and transmits the generated public key to the transmission-side device 11.

Step S5: Like the reception-side device 12, the transmission-side device 11 generates a secret key and a public key by a DH (Diffie-Hellman) method, and transmits the generated public key to the reception-side device 12. In addition, by using the generated secret key and the public key that is transmitted from the reception-side device 12, the transmission-side device 11 generates a secret key (common key) which is used in the subsequent communication.

Step S6: Similarly, by using the generated secret key and the public key that is transmitted from the transmission-side device 11, the reception-side device 12 generates a secret key (common key) which is used in the subsequent communication. Further, the reception-side device 12 generates a random number, and displays the generated random number on the display screen of the reception-side device 12.

Step S7: The reception-side device 12 encrypts the displayed random number by the common key, and transmits the encrypted random number to the transmission-side device 11.

Step S8: The transmission-side device 11 decrypts the encrypted random number, which is transmitted from the reception-side device 12, by the common key in the transmission-side device 11, displays the decrypted random number on the display screen of the transmission-side device 11, and prompts the user to confirm the random number.

Step S9: Upon confirming that the random number that is displayed on the display screen of the transmission-side device 11 agrees with the random number that is displayed on the display screen of the reception-side device 12, the user presses, for example, the setup button 36 of the transmission-side device 11. If the setup button 36 is pressed, the transmission-side device 11 encrypts data that is to be kept secret, such as login information, by the common key in the transmission-side device 11, and transmits the encrypted data to the reception-side device 12. On the other hand, if the random number that is displayed on the display screen of the transmission-side device 11 does not agree with the random number that is displayed on the display screen of the reception-side device 12, the user presses, for example, the power button 39 of the transmission-side device 11. When the power button 39 is pressed, the transmission-side device 11 transmits to the reception-side device 12 the information for disconnecting the communication path between the transmission-side device 11 and the reception-side device 12.

Step S10: The reception-side device 12 decrypts the encrypted data, which is received in step S9, by the common key in the reception-side device 12. Then, the reception-side device 12 transmits to the transmission-side device 11 a notice of reception completion which indicates that the data has been correctly received.

Subsequently, the reception-side device 12 starts a login process by using the login information which is transmitted from the transmission-side device 11. If the login process is successfully carried out, the transmission-side device 11 is enabled to transmit information, such as video-recording programming information, to the reception-side device 12. The video-recording programming information is also encrypted by the common key in the transmission-side device 11, and the encrypted information is transmitted to the reception-side device 12.

In the above-described example, the DH (Diffie-Hellman) method is used. Alternatively, an RSA public-key cryptosystem or other common-key cryptosystems may be used.

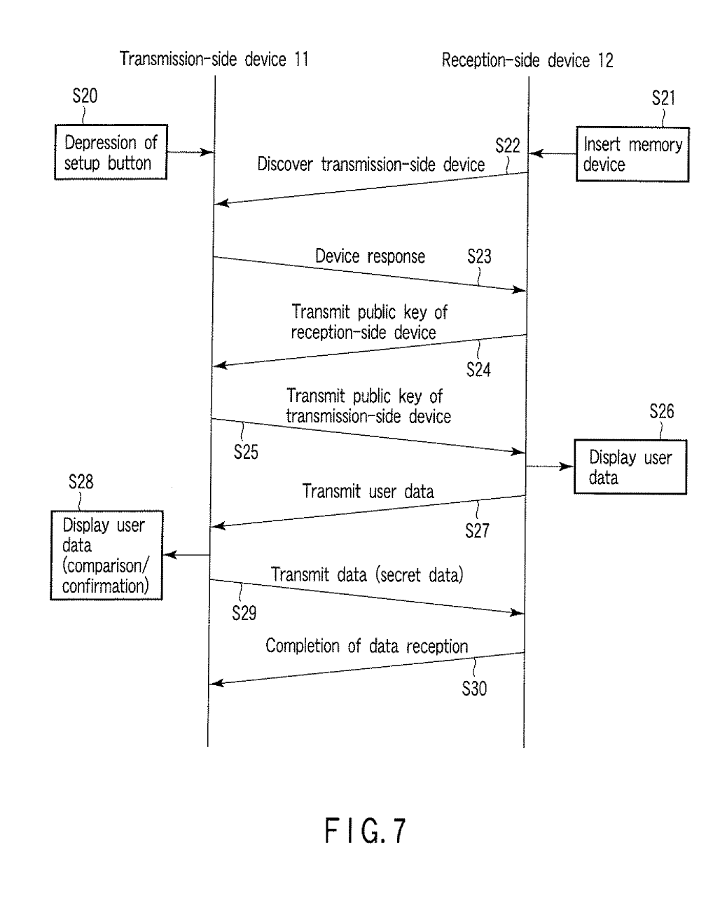

Next, referring to FIG. 7, a description is given of another example of the procedure of a series of processes for transmitting data from the transmission-side device 11 to the reception-side device 12. In FIG. 7, it is assumed that user data, which is stored in the memory device 13, is used as the above-described connection confirmation information.

For example, TCP/IP or UDP/IP is used for the communication between the transmission-side device 11 and the reception-side device 12. It is also assumed that the transmission-side device 11 and the reception-side device 12 belong to the same subnet.

Step S20: If the user presses, for example, the setup button 36 of the transmission-side device 11 the transmission-side device 11 starts a communication protocol for connection to a reception-side device, and first transitions into a standby state. In the standby state, the transmission-side device 11 waits for a discover packet from the reception-side device, for example, at UDP port No. 33333.

Step S21: If the user inserts/connects the memory device 13 in/to the reception-side device 12, the reception-side device 12 starts a communication protocol for connection to a transmission-side device.

Step S22: The reception-side device 12 first broadcasts a packet which designates UDP/IP port No. 33333, thereby to discover the transmission-side device 11.

Step S23: The transmission-side device 11, which has received this broadcast packet, transmits a UDP/IP packet including the IP address of the transmission-side device 11 to the reception-side device 12 (device response).

Step S24: The reception-side device 12 generates a secret key and a public key, for example, by a DH (Diffie-Hellman) method, and transmits the generated public key to the transmission-side device 11.

Step S25: Like the reception-side device 12, the transmission-side device 11 generates a secret key and a public key by a DH (Diffie-Hellman) method, and transmits the generated public key to the reception-side device 12. In addition, by using the generated secret key and the public key that is transmitted from the reception-side device 12, the transmission-side device 11 generates a secret key (common key) which is used in the subsequent communication.

Step S26: Similarly, by using the generated secret key and the public key that is transmitted from the transmission-side device 11, the reception-side device 12 generates a secret key (common key) which is used in the subsequent communication. Further, the reception-side device 12 reads out user data (e.g. image data such as photo image data) which is stored in the memory device 13, and displays the user data on the display screen of the reception-side device 12.

Step S27: The reception-side device 12 encrypts the displayed user data by the common key, and transmits the encrypted user data to the transmission-side device 11.

Step S28: The transmission-side device 11 decrypts the encrypted user data, which is transmitted from the reception-side device 12, by the common key in the transmission-side device 11, displays the decrypted user data on the display screen of the transmission-side device 11, and prompts the user to confirm the user data.

Step S29: Upon confirming that the user data that is displayed on the display screen of the transmission-side device 11 agrees with the user data that is displayed on the display screen of the reception-side device 12, the user presses, for example, the setup button 36 of the transmission-side device 11. If the setup button 36 is pressed, the transmission-side device 11 encrypts data that is to be kept secret, such as login information, by the common key in the transmission-side device 11, and transmits the encrypted data to the reception-side device 12. On the other hand, if the user data that is displayed on the display screen of the transmission-side device 11 does not agree with the user data that is displayed on the display screen of the reception-side device 12, the user presses, for example, the power button 39 of the transmission-side device 11. When the power button 39 is pressed, the transmission-side device 11 transmits to the reception-side device 12 the information for disconnecting the communication path between the transmission-side device 11 and the reception-side device 12.

Step S30: The reception-side device 12 decrypts the encrypted data, which is received in step S29, by the common key in the reception-side device 12. Then, the reception-side device 12 transmits to the transmission-side device 11 a notice of reception completion which indicates that the data has been correctly received.

Subsequently, the reception-side device 12 starts a login process. If the login process is successfully carried out, the transmission-side device 11 is enabled to transmit information, such as video-recording programming information, to the reception-side device 12. The video-recording programming information is also encrypted by the common key in the transmission-side device 11, and the encrypted information is transmitted to the reception-side device 12.

In the above-described example, the reception-side device 12 starts the communication protocol in response to the insertion of the memory device 13 in the reception-side device 12. Alternatively, the reception-side device 12 may be configured to start the communication protocol in response to the operation of the setup button of the reception-side device 12.

As has been described above, in the present embodiment, the value of the random number or the user data (e.g. image data) is transmitted from the reception-side device 12 to the transmission-side device 11, and the value of the random number or the user data is displayed on the display screen of the transmission-side device 11. Thus, the user can determine whether the transmission-side device 11 is connected to the reception-side device that is intended by the user, simply by confirming the value of the random number or the user data which is displayed on the display screen of the transmission-side device 11. Therefore, the data that is to be kept secret can be transmitted to the correct counterpart device, without the user himself/herself inputting data such as a PIN code.

The network 10 may be a wired network or a wireless network.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus which transmits data, which is to be kept secret, to a device via a network, comprising:
a display process unit configured to display, on a display screen of the electronic apparatus, connection confirmation information which is known to a user and is transmitted from the device via the network during a connection establishing process for establishing connection between the device and the electronic apparatus; and
a data transmission process unit configured to start a process of transmitting the data that is to be kept secret to the device via the network in response to a predetermined user operation which indicates that the user has confirmed that the connection confirmation information displayed on the display screen is correct.

2. The electronic apparatus according to claim 1, further comprising a key generation process unit configured to execute, in the connection establishing process/a process for exchanging a key between the device and the electronic apparatus via the network, thereby generating a secret key which is shared by the device and the electronic apparatus,
wherein the connection confirmation information, which is transmitted from the device via the network, is encrypted by the secret key,
the display process unit decrypts the encrypted connection confirmation information by the secret key that is generated by the key generation process unit, and displays the decrypted connection confirmation information on the display screen, and
the data transmission process unit encrypts the data that is to be kept secret by the secret key, which is generated by the key generation process unit, in response to the predetermined user operation, and transmits the data, which is obtained by the encrypting, to the device via the network.

3. The electronic apparatus according to claim 1, wherein the connection confirmation information is a random number which is generated by the device, and the generated random number is displayed on a display screen of the device.

4. The electronic apparatus according to claim 1, wherein the connection confirmation information is user data which is stored in a memory device which is connected to the device.

5. The electronic apparatus according to claim 4, wherein the user data is image data.

6. A communication system which transmits data, which is to be kept secret, from an electronic apparatus to a device via a network, comprising:
a connection confirmation information transmission process unit provided in the device and configured to transmit, during a connection establishing process for establishing connection between the device and the electronic apparatus, connection confirmation information which is known to a user to the electronic apparatus via the network;
a display process unit provided in the electronic apparatus and configured to display, on a display screen of the electronic apparatus, the connection confirmation information which is transmitted from the device via the network; and
a data transmission process unit provided in the electronic apparatus and configured to start a process of transmitting the data that is to be kept secret to the device via the network in response to a predetermined user operation which indicates that the user has confirmed that the connection confirmation information displayed on the display screen is correct.

7. The communication system according to claim 6, further comprising a key generation process unit provided in the electronic apparatus and configured to execute, in the connection establishing process, a process for exchanging a key between the device and the electronic apparatus via the network, thereby generating a secret key which is shared by the device and the electronic apparatus,
wherein the connection confirmation information, which is transmitted from the device via the network, is encrypted by the secret key,
the display process unit decrypts the encrypted connection confirmation information by the secret key that is generated by the key generation process unit, and displays the decrypted connection confirmation information on the display screen, and
the data transmission process unit encrypts the data that is to be kept secret by the secret key, which is generated by the key generation process unit, in response to the predetermined user operation, and transmits the data, which is obtained by the encrypting, to the device via the network.

8. A communication method for transmitting data, is which is to be kept secret, from an electronic apparatus to a device via a network, comprising:
transmitting, during a connection establishing process for establishing connection between the device and the electronic apparatus, connection confirmation information which is known to a user from the device to the electronic apparatus via the network;
displaying, on a display screen of the electronic apparatus, the connection confirmation information which is transmitted from the device via the network; and
starting a process of transmitting the data, which is to be kept secret, from the electronic apparatus to the device via the network in response to a predetermined user operation which indicates that the user has confirmed that the connection confirmation information displayed on the display screen is correct.

9. The communication method according to claim 8, further comprising executing, in the connection establishing process, a process for exchanging a key between the device and the electronic apparatus via the network, thereby generating a secret key which is shared by the device and the electronic apparatus,
wherein the connection confirmation information, which is transmitted from the device via the network, is encrypted by the secret key,
said displaying includes decrypting the encrypted connection confirmation information by the secret key that is generated by the key generation process unit, and displaying the decrypted connection confirmation information on the display screen, and
said starting the process of transmitting the data that is to be kept secret includes encrypting the data that is to be kept secret by the generated secret key in response to the predetermined user operation, and transmitting the data, which is obtained by the encrypting, from the electronic device to the device via the network.

10. The communication method according to claim 8, wherein the connection confirmation information is a random number which is generated by the device, and the generated random number is displayed on a display screen of the device.

11. The communication method according to claim 8, wherein the connection confirmation information is user data which is stored in a memory device which is connected to the device.
